(19) United States
(12) Patent Application Publication
(10) Pub. No.: US 2025/0190811 A1
(43) Pub. Date: Jun. 12, 2025

(54) METHOD FOR TRAINING MULTIMODAL LARGE MODEL AND ELECTRONIC DEVICE

(71) Applicant: BEIJING BAIDU NETCOM SCIENCE TECHNOLOGY CO., LTD., Beijing (CN)

(72) Inventors: Shuohuan Wang, Beijing (CN); Junyuan Shang, Beijing (CN); Yekun Chai, Beijing (CN); Yinqi Yang, Beijing (CN); Zhenyu Zhang, Beijing (CN); Yu Sun, Beijing (CN); Hua Wu, Beijing (CN); Haifeng Wang, Beijing (CN)

(73) Assignee: BEIJING BAIDU NETCOM SCIENCE TECHNOLOGY CO., LTD., Beijing (CN)

(21) Appl. No.: 19/062,883

(22) Filed: Feb. 25, 2025

(30) Foreign Application Priority Data
Sep. 27, 2024 (CN) 202411367548.X

(51) Int. Cl. G06N 3/096; G06N 3/045; G06V 10/77; G06V 10/82

(52) U.S. Cl. CPC G06N 3/096; G06N 3/045; G06V 10/7715; G06V 10/82

(57) ABSTRACT

A method for training a multimodal large model includes: obtaining first training data and second training data; obtaining an initial multimodal large model, wherein the multimodal large model comprises a backbone network and multiple codec networks corresponding to the multiple non-textual modalities; and the multiple codec networks perform encoding and decoding based on a same multimodal word list; performing a joint training on the multiple codec networks and the multimodal word list based on the data under the multiple non-textual modalities; and training the backbone network based on the multimodal sample reference data and the sample generation data under the target task in the second training data. The multiple codec networks perform the encoding and decoding based on the same multimodal word list, which reduces the difficulty and the cost of the model training.

### CROSS-REFERENCE TO RELATED APPLICATION

This application claims priority to and benefits of Chinese Patent Application Serial No. 202411367548.X, filed with the State Intellectual Property Office of P.R. China on Sep. 27, 2024, the entire content of which is incorporated herein by reference.

### TECHNICAL FIELD

The present disclosure relates to the technical field of artificial intelligence, and in particular to the technical fields of deep learning, natural language processing, computer vision, speech technology, large model, and etc., and in particular to a method for training a multimodal large model, and an electronic device.

### BACKGROUND

The current multimodal large model, such as a video generation model, includes a coding network, a backbone network, and a decoding network. There are three coding networks, i.e., a coding network corresponding to a video modality, a coding network corresponding to a textual modality, and a coding network corresponding to an audio modality.

In the above video generation model, coding networks corresponding to different modalities use word lists of different modalities, and are obtained by training separately using data of different modalities. Thus, training may be performed for the word lists of different modalities separately during a training process of the video generation model, which increases the difficulty and the cost of the model training.

### SUMMARY

According to an aspect of embodiments of the present disclosure, a method for training a multimodal large model is provided. The method includes: obtaining first training data and second training data; in which the first training data includes data under multiple non-textual modalities; and the second training data includes multimodal sample reference data and sample generation data under a target task; obtaining an initial multimodal large model; in which the multimodal large model includes a backbone network and multiple codec networks corresponding to the multiple non-textual modalities; and the multiple codec networks perform encoding and decoding based on a same multimodal word list; performing a joint training on the multiple codec networks and the multimodal word list based on the data under the multiple non-textual modalities; and in response to the training of the multiple codec networks and the multimodal word list being completed, training the backbone network based on the multimodal sample reference data and the sample generation data under the target task.

According to another aspect of the present disclosure, a method for processing a target task is provided. The method includes: obtaining a target task; in which the target task includes data under at least two modalities; obtaining a multimodal large model; in which the multimodal large model is obtained based on the method for training a multimodal large model described above; and obtaining generated data output by the multimodal large model, by inputting the data under the at least two modalities into the multimodal large model.

According to another aspect of the present disclosure, an electronic device is provided. The electronic device includes: at least one processor; and a memory communicatively coupled to the at least one processor and storing instructions executable by the at least one processor; in which when the instructions are executed by the at least one processor, the at least one processor is caused to perform the method for training a multimodal large model, or the method for processing a target task provided in the disclosure.

According to another aspect of the present disclosure, a non-transitory computer readable storage medium is provided. The non-transitory computer readable storage medium stores computer instructions, in which the computer instructions are configured to cause a computer to perform the method for training a multimodal large model, or the method for processing a target task provided in the disclosure.

It should be understood that what is described in this section is not intended to identify key or important features of embodiments of the present disclosure, nor is it intended to limit the scope of the present disclosure. Other features of the present disclosure will be readily understood by the following specification.

### BRIEF DESCRIPTION OF THE DRAWINGS

The accompanying drawings are used for a better understanding of the present disclosure and do not constitute a limitation of the present disclosure.

FIG. 1 is a schematic diagram illustrating a first embodiment according to the present disclosure.

FIG. 2 is a schematic diagram illustrating a second embodiment according to the present disclosure.

FIG. 3 is a schematic diagram illustrating a third embodiment according to the present disclosure.

FIG. 4 is a schematic diagram illustrating training of multiple codec networks in a multimodal large model.

FIG. 5 is a schematic diagram illustrating a fourth embodiment according to the present disclosure.

FIG. 6 is a schematic diagram illustrating a fifth embodiment according to the present disclosure.

FIG. 7 is a schematic diagram illustrating a sixth embodiment according to the present disclosure.

FIG. 8 is a block diagram illustrating an electronic device configured to implement a method for training a multimodal large model or a method for processing a target task according to embodiments of the present disclosure.

### DETAILED DESCRIPTION

Embodiments of the present disclosure are described hereinafter in conjunction with the accompanying drawings, which include various details of the embodiments of the present disclosure to aid in understanding, and should be considered exemplary only. Accordingly, those skilled in the art should recognize that various changes and modifications can be made to the embodiments described herein without departing from the scope and spirit of the present disclosure. Similarly, descriptions of well-known features and structures are omitted from the following description for the sake of clarity and brevity.

The current multimodal large model, such as a video generation model, includes a coding network, a backbone network, and a decoding network. There are three coding networks, i.e., a coding network corresponding to a video modality, a coding network corresponding to a textual modality, and a coding network corresponding to an audio modality.

In the above video generation model, coding networks corresponding to different modalities may be obtained by training separately using different data of different modalities, using word lists of different modalities, so that training may be performed for word lists of different modalities separately during the training process of the video generation model, which improves the difficulty and the cost of the model training.

To solve the above problems, the present disclosure provides a method and an apparatus for training a multimodal large model, and an electronic device.

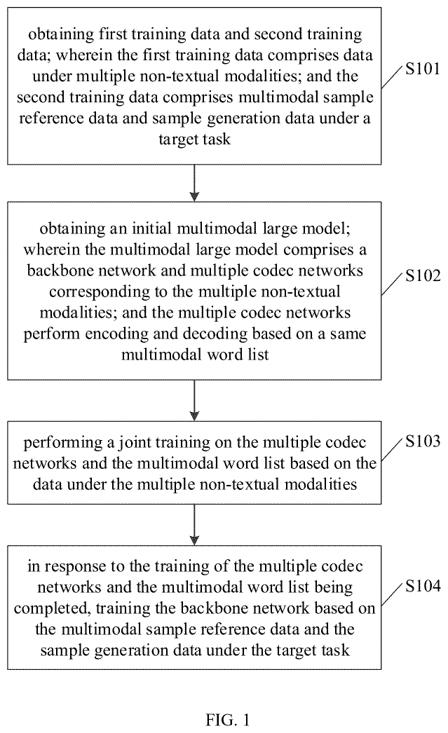

FIG. 1 is a schematic diagram illustrating a first embodiment according to the present disclosure. It should be noted that the method for training a multimodal large model in embodiments of the present disclosure may be performed by an apparatus for training a multimodal large model, which may be configured in an electronic device to enable the electronic device to perform a function for training a multimodal large model. In the following embodiments, the execution subject is illustrated as the electronic device.

The electronic device may be any device with computing capabilities, such as a personal computer (PC), a mobile terminal, a server, etc. The mobile terminal can be, for example, an in-vehicle device, a phone, a tablet, a personal digital assistant, a wearable device, a smart speaker, a server, a server cluster, or other hardware devices with various operating systems, touch screens, and/or displays.

The apparatus for training a multimodal large model may also be a software in the electronic device, such as software for training a multimodal large model etc. In the following embodiments, the apparatus for training a multimodal large model is illustrated as the electronic device.

As shown in FIG. 1, the method for training a multimodal large model may include the following steps 101 to 104.

At step 101, first training data and second training data are obtained; in which the first training data includes data under multiple non-textual modalities; and the second training data includes multimodal sample reference data and sample generation data under a target task.

In an embodiment of the present disclosure, the non-textual modality includes at least one of: an audio modality, a silent video modality, or an image modality. For example, the data under the audio modality includes an audio, the data under the silent video modality includes a silent video, and the data under the image modality includes images. A sound video can be divided into data under the two non-textual modalities. For example, the sound video can be divided into data under the audio modality and data under the video modality.

The configuration of the multiple non-textual modalities enables the multimodal large model to flexibly process data under different textual modalities, thus expanding the application scenarios of the multimodal large model and improving the processing efficiency of the multimodal large model.

In an embodiment of the present disclosure, the target task includes at least one of: an image generation task, a video generation task, an audio generation task, a text generation task, or a multi-modality understanding task.

The multimodal sample reference data under the multiple target tasks may, for example, include sample reference data under at least one of the following modalities: a textual modality, an image modality, a video modality, or an audio modality. The multi-modality understanding task refers to a task of understanding input multimodal data to output the understood text. The input multimodal data during the understanding may include data under at least one of the following modalities: the textual modality, the image modality, the video modality, or the audio modality.

The configuration of the multimodal sample reference data and the sample generation data under the multiple target tasks enables the multimodal large model to train a model applicable to different target tasks based on the training data, thus expanding the application scenarios of the tasks of the multimodal large model and further improving the processing efficiency of the multimodal large model.

At step 102, an initial multimodal large model is obtained; in which the multimodal large model includes a backbone network and multiple codec networks corresponding to the multiple non-textual modalities; and the multiple codec networks perform encoding and decoding based on a same multimodal word list.

In an embodiment of the present disclosure, there may be multiple codec networks, for example, a one-dimensional codec network, a two-dimensional codec network, a three-dimensional codec network, and etc. For example, the non-textual modality includes the audio modality, the silent video modality, and the image modality. A codec network corresponding to the audio modality is a one-dimensional codec network; a codec network corresponding to the image modality is a two-dimensional codec network; and a codec network corresponding to the silent video modality is a three-dimensional codec network.

The multiple codec networks use the same multimodal word list. The multimodal word list may include a plurality of integer identifiers and vectors corresponding to plurality of integer identifier respectively. A vector in the multimodal word list may represent an image, an audio, and a video at the same time. That is, a vector in the multimodal word list may be a vector of an image block in an image, or, a vector of an audio segment in an audio, or, a vector of a video block in a video.

Different codec networks are used to process the data in different non-textual modalities, so as to extract features from the data under the non-textual modalities as much as possible and improve the accuracy of the extracted features.

In an embodiment of the present disclosure, in the case that the codec network is the two-dimensional codec network, a method for processing an image under the image modality based on a coding network in the two-dimensional codec network includes: obtaining a two-dimensional image feature by inputting the image into the coding network in the two-dimensional codec network; obtaining a deformed one-dimensional feature vector by performing a one-dimensional deformation on the two-dimensional image feature; and obtaining an integer sequence corresponding to the image by performing mapping on features in the one-dimensional feature vector based on the multimodal word list.

In the case that the codec network is the one-dimensional codec network, a method for processing an audio under the audio modality based on a coding network in the one-dimensional codec network includes: obtaining a one-dimensional audio feature by inputting the audio into the coding network in the one-dimensional codec network; in which the one-dimensional audio feature is a one-dimensional feature vector; and obtaining an integer sequence corresponding to the audio by performing mapping on features in the one-dimensional feature vector based on the multimodal word list.

In the case that the codec network is the three-dimensional codec network, a method for processing a video under the video modality based on a coding network in the three-dimensional codec network includes: obtaining a three-dimensional video feature by inputting the video into the coding network in the three-dimensional codec network; obtaining a deformed one-dimensional feature vector by performing a one-dimensional deformation on the three-dimensional video feature; and obtaining an integer sequence corresponding to the video by performing mapping on features in the one-dimensional feature vector based on the multimodal word list.

After the coding networks in the multiple dimensional codec networks encode the data, the one-dimensional deformation is performed on the features obtained by encoding, so that a one-dimensional feature vector can be obtained for the data under each of the multiple modalities, thus mapping can be performed on features based on the same multimodal word list. The interaction between the multiple modalities is realized, thus further improving the accuracy of the feature extraction of the coding networks in the multiple dimensional codec networks.

At step 103, a joint training is performed on the multiple codec networks and the multimodal word list based on the data under the multiple non-textual modalities.

In an embodiment of the present disclosure, the electronic device may determine a total loss function value of the multiple codec networks based on the data under the multiple non-textual modalities and the multiple codec networks; and the joint training is performed by adjusting, based on the total loss function value, the both the parameters of multiple codec networks and the multimodal word list.

At step 104, in response to the training of the multiple codec networks and the multimodal word list being completed, the backbone network is trained based on the multimodal sample reference data and the sample generation data under the target task.

In an embodiment of the present disclosure, the backbone network may, for example, be an autoregressive model. The autoregressive model is a time series analysis model that uses a linear combination of past values of a variable plus a random error term to predict future values of the variable.

The electronic device may determine an integer sequence or a predicted integer sequence combination corresponding to the predicted generation data based on the multimodal sample reference data, the multiple codec networks corresponding to the multiple non-textual modalities, and the backbone network; determine a modality to which the sample generation data belongs; determine an integer sequence or a predicted integer sequence combination corresponding to the sample generation data based on the sample generation data and the coding networks in the codec networks corresponding to respective modalities to which the sample generation data belongs; determine a loss function value based on the integer sequences or the predicted integer sequence combination corresponding to the predicted generation data and the integer sequences or the predicted integer sequence combination corresponding to the sample generation data; and perform the training by adjusting the parameter of the backbone network.

In embodiments of the present disclosure, a method for training a multimodal large model is provided. The method includes: obtaining the first training data and the second training data; in which the first training data includes the data under the multiple non-textual modalities; and the second training data includes the multimodal sample reference data and the sample generation data under the target task; obtaining the initial multimodal large model; in which the multimodal large model includes the backbone network and multiple codec networks corresponding to the multiple non-textual modalities; and the multiple codec networks perform encoding and decoding based on the same multimodal word list; performing the joint training on the multiple codec networks and the multimodal word list based on the data under the multiple non-textual modalities; and in response to the training of the multiple codec networks and the multimodal word list being completed, training the backbone network based on the multimodal sample reference data and the sample generation data under the target task. The multiple codec networks perform encoding and decoding and the joint training based on the same multimodal word list, avoiding training word lists of different modalities separately during the training process, thus reducing the difficulty and the cost of the model training.

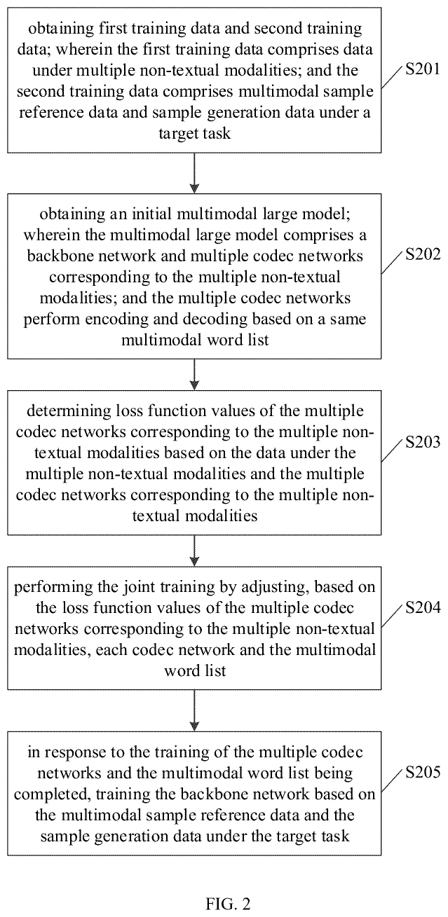

To further improve the training speed of the codec networks corresponding to the multiple non-textual modalities, loss function values of the multiple codec networks can be determined respectively based on the data under the multiple non-textual modalities; and each codec network and the multimodal word list are adjusted based on the loss function values. As shown in FIG. 2, it is a schematic diagram illustrating a second embodiment according to the present disclosure. The embodiments shown in FIG. 2 may include the following steps 201 to 205.

At step 201, first training data and second training data are obtained; in which the first training data includes data under multiple non-textual modalities; and the second training data includes multimodal sample reference data and sample generation data under a target task.

At step 202, an initial multimodal large model is obtained; in which the multimodal large model includes a backbone network and multiple codec networks corresponding to the multiple non-textual modalities; and the multiple codec networks perform encoding and decoding based on a same multimodal word list.

At step 203, loss function values of the multiple codec networks corresponding to the multiple non-textual modalities are determined based on the data under the multiple non-textual modalities and the multiple codec networks corresponding to the multiple non-textual modalities.

In an embodiment of the present disclosure, a process of performing step 203 by the electronic device may, for example, include: determining predicted data corresponding to the data under the multiple non-textual modalities based on the data under the multiple non-textual modalities and the multiple codec networks corresponding to the multiple non-textual modalities; determining, for each non-textual modality, a true-false discriminatory result based on the data under the non-textual modality, the predicted data corresponding to the data under the non-textual modality, and a discriminatory network in a codec network corresponding to the non-textual modality; and determining a loss function value of the codec network corresponding to the non-textual modality based on at least one of the true-false discrimination result, a difference between the data and the predicted data, or a difference in features between the data and the predicted data.

In an embodiment of the present disclosure, in the case that at least two candidate data with an association relationship do not exist in the data under the multiple non-textual modalities, a process of the electronic device determining the predicted data corresponding to the data under the multiple non-textual modalities may, for example, include: obtaining, for each non-textual modality, predicted data corresponding to data under the non-textual modality by inputting the data under the non-textual modality into a codec network corresponding to the non-textual modality, sequentially.

In particular, for each non-textual modality, the codec network corresponding to the non-textual modality may include a coding network and a decoding network. The electronic device may determine an integer sequence corresponding to data under the non-textual modality based on the data under the non-textual modality and the coding network; and determine predicted data corresponding to the data under the non-textual modality based on the integer sequence and the decoding network.

In particular, the electronic device may obtain an output data feature by inputting the data under the non-textual modality into the encoding network; in the case that the data feature is a multidimensional feature vector, obtain a one-dimensional feature vector by performing a one-dimensional deformation on the data feature; and obtain an integer sequence corresponding to the data under the non-textual modality by performing mapping on features in the one-dimensional feature vector based on the multimodal word list.

In particular, the electronic device may determine a predicted data feature corresponding to the data under the non-textual modality based on the multimodal word list and the integer sequence corresponding to the data under the non-textual modality; and obtain predicted data corresponding to the data output by the decoding network by inputting the predicted data feature corresponding to the data under the non-textual modality into the decoding network.

It should be noted that a combination of at least two candidate data with the association relationship includes: a sound video. The configuration of the sound video and an image with sound enables the multimodal large model to extract interactive features between the at least two modalities, improving the accuracy of the extracted features.

In the case that the at least two candidate data with the association relationship do not exist in the data under the multiple non-textual modalities, the data under the multiple non-textual modalities do not have an association relationship with each other. The predicted data can be obtained by processing the data under the multiple non-textual modalities respectively, so that the data under the multiple non-textual modalities can be processed in parallel, thus improving the efficiency of the data processing.

In an embodiment of the present disclosure, in the case that the at least two candidate data exist in the data under the multiple non-textual modalities, for the at least two candidate data, the electronic device may obtain at least two data features corresponding to the at least two candidate data respectively, by inputting the at least two candidate data into coding networks in codec networks corresponding to respective modalities to which the at least two candidate data belong, respectively. A processed one-dimensional feature vector is obtained by performing a one-dimensional deformation and a bitwise addition on the at least two data features. A processed integer sequence is obtained by performing mapping on features in the processed one-dimensional feature vector based on the multimodal word list. Predicted data corresponding to the at least two candidate data is obtained based on the processed integer sequence and decoding networks in the codec networks corresponding to the respective modalities to which the at least two candidate data belong.

In particular, the electronic device may determine predicted data features based on the multimodal word list and the processed integer sequence; and obtain predicted data corresponding to the at least two candidate data by inputting the predicted data features into decoding networks in codec networks corresponding to respective modalities to which the at least two candidate data belong, respectively.

After performing the bitwise addition on the data features corresponding to the at least two candidate data with the association relationship, feature mapping is performed based on the multimodal word list, which can realize the feature interaction between the at least two candidate data, avoiding fragmentation between the at least two candidate data, and thus can further improving the training efficiency of the codec network.

The codec networks corresponding to the multiple non-textual modalities may also include a discrimination network. The discrimination network discriminates the truth or falsity of the predicted data corresponding to the data under the non-textual modality based on the data under the non-textual modality. A true-false discrimination result may be that the predicted data is true; or, the predicted data is false. The difference between the data and the predicted data in terms of the true-false discrimination can be determined based on the true-false discrimination result.

The difference between the data and the predicted data may be determined based on a similarity between the data and the predicted data. The difference in features between the data and the predicted data may be a difference in at least one of the following aspects: a difference between target information in the data and target information in the predicted data; a difference between descriptive contents in the data and descriptive contents in the predicted data; or a difference between a Fourier transform result of the data and a Fourier transform result of the predicted data, etc., which can be set according to the actual needs.

The loss function value of the codec network corresponding to the non-textual modality is determined based on the differences in various aspects between the data under the non-textual modality and the predicted data. The accuracy of the determined loss function value can be further improved, thus further improving the training accuracy of the multiple codec networks.

At step 204, the joint training is performed by adjusting, based on the loss function values of the multiple codec networks corresponding to the multiple non-textual modalities, each codec network and the multimodal word list.

In an embodiment of the present disclosure, the process of performing step 204 by the electronic device may, for example, include: obtaining a total loss function value by summing the loss function values of the multiple codec networks corresponding to the multiple non-textual modalities; and performing the joint training by adjusting, based on the total loss function value, parameters of the multiple codec networks and a vector corresponding to an integer identifier in the multimodal word list.

By adjusting the parameters of the multiple codec networks and a vector corresponding to an integer identifier in the multimodal word list based on the total loss function value, the vector corresponding to the integer identifier in the multimodal word list can reflect the features under the multiple non-textual modalities, thus further improving the accuracy of the trained codec networks.

At step 205, in response to the training of the multiple codec networks and the multimodal word list being completed, the backbone network is trained based on the multimodal sample reference data and the sample generation data under the target task.

It should be noted that the details of steps 201 to step 202, and step 205 can be referred to steps 101 to step 102, and step 104 in the embodiments shown in FIG. 1, and will not be described in detail herein.

With the method for training a multimodal large model according to embodiments of the present disclosure, the first training data and the second training data are obtained, in which the first training data includes data under multiple non-textual modalities, and the second training data includes the multimodal sample reference data and the sample generation data under the target task, the initial multimodal large model is obtained, in which the multimodal large model includes the backbone network and the multiple codec networks corresponding to the multiple non-textual modalities, and the multiple codec networks perform encoding and decoding based on the same multimodal word list, loss function values of the multiple codec networks corresponding to the multiple non-textual modalities are obtained based on the data under the multiple non-textual modalities and the multiple codec networks corresponding to the multiple non-textual modalities, the joint training is performed by adjusting each codec network and the multimodal word list based on the loss function values of the multiple codec networks corresponding to the multiple non-textual modalities, and in response to the training of the multiple codec networks and the multimodal word list being completed, and the backbone network is trained based on the multimodal sample reference data and the sample generation data under the target task. The loss function values of the multiple codec networks can be determined respectively, and each codec network and the multimodal word list are adjusted based on the loss function values, which can further improve the training speed and training accuracy of the codec networks corresponding to the multiple non-textual modalities.

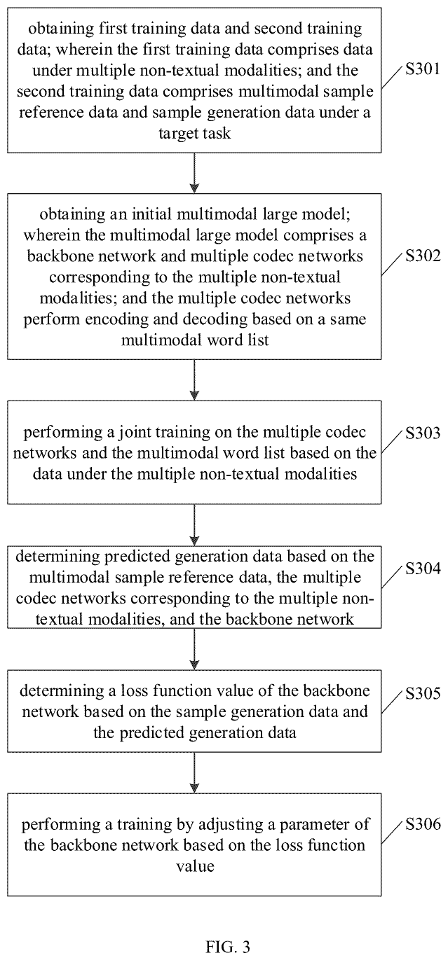

To further improve the training accuracy of the backbone network, the electronic device may determine predicted generation data based on the multimodal sample reference data, the multiple codec networks corresponding to the multiple non-textual modalities, and the backbone network, and then determine a loss function value of the backbone network for adjustment. As shown in FIG. 3, it is a schematic diagram illustrating a third embodiment according to the present disclosure. The embodiment shown in FIG. 3 may include the following steps 301 to 306.

At step 301, first training data and second training data are obtained; in which the first training data includes data under multiple non-textual modalities; and the second training data includes multimodal sample reference data and sample generation data under a target task.

At step 302, an initial multimodal large model is obtained; in which the multimodal large model includes a backbone network and multiple codec networks corresponding to the multiple non-textual modalities; and the multiple codec networks perform encoding and decoding based on a same multimodal word list.

At step 303, a joint training is performed on the multiple codec networks and the multimodal word list based on the data under the multiple non-textual modalities.

At step 304, predicted generation data is determined based on the multimodal sample reference data, the multiple codec networks corresponding to the multiple non-textual modalities, and the backbone network.

In an embodiment of the present disclosure, the multimodal sample reference data includes data under at least two of following modalities: an audio modality, a silent video modality, an image modality, or a text modality; and the sample generation data includes data under at least one of following modalities: an audio modality, a silent video modality, an image modality, or a text modality.

The flexible configuration of the multimodal sample reference data and the data of the multiple modalities in the sample generation data enables the trained multimodal large model to be applicable to different target tasks, thus expanding the application scenarios of the multimodal large model.

In an embodiment of the present disclosure, the process of performing step 304 by the electronic device may, for example, include: determining a multimodal integer sequence combination based on the multimodal sample reference data and coding networks in the multiple codec networks corresponding to the multiple non-textual modalities; in which integer sequences under different modalities in the multimodal integer sequence combination are distinguished through modality markers; obtaining predicted integer sequences or a predicted integer sequence combination output by the backbone network, by inputting the multimodal integer sequence combination into the backbone network; and obtaining the predicted generation data, by inputting the predicted integer sequences or predicted integer sequences in the predicted integer sequence combination into decoding networks in the multiple codec networks corresponding to the multiple modalities, respectively.

The multimodal sample reference data may include sample reference data from various candidate non-textual modalities, and sample text data from the text modality. Correspondingly, the process of the electronic device determining the multimodal integer sequence combination may include, for example, determining, for each candidate non-textual modality, an integer sequence under the candidate non-textual modality based on the sample reference data under the candidate non-textual modality and a coding network in a codec network corresponding to the candidate non-textual modality; and obtaining the multimodal integer sequence combination by splicing integer sequences under the multiple candidate non-textual modalities and an integer sequence corresponding to the sample text data based on the modality markers.

It should be noted that the electronic device may be configured with a text word list for the text. The text word list includes integer identifiers and corresponding words. The electronic device can obtain multiple words by dividing the data in the sample text data into words; and obtain the integer identifiers corresponding to the multiple words by querying the text word list based on the multiple words, and then obtain an integer sequence corresponding to the sample text data by combining the integer identifiers.

In the case that the target task includes an image generation task, a video generation task, an audio generation task, or a text generation task, the predicted generation data output by the multimodal large model is the data under a single modality. Accordingly, the backbone network may output predicted integer sequences. In the case that the target task is a multi-output task, e.g., a graphic generation task, an audio-video generation task, and other tasks, the predicted generation data output by the multimodal large model is data under multiple modalities. Accordingly, the backbone network may output a predicted integer sequence combination.

The modality markers can be set for the predicted integer sequences output by the backbone network. A modality marker can be set for each of the predicted integer sequences in the predicted integer sequence combination output by the backbone network. Based on the modality markers, it can be determined which decoding network corresponding to the non-textual modality is used for decoding the predicted integer sequences, so as to perform targeted decoding.

The modality markers of the integer sequences under the multiple non-textual modalities and the word sequences corresponding to the sample text data enables the backbone network to distinguish integer sequences under different modalities for learning processing, thus further improving the training speed and training accuracy of the backbone network.

In an embodiment of the present disclosure, in the case that at least two candidate sample reference data under the non-textual modality with an association relationship exist in the multimodal sample reference data, for example, the multimodal sample reference data including the sound video data, the electronic device may determine data features of the sample reference data under the at least two candidate non-textual modalities based on the coding networks in the codec networks under the multiple modalities. In the case that the data features are multidimensional feature vectors, one-dimensional feature vectors are obtained by performing a one-dimensional deformation on the data feature. A processed one-dimensional feature vectors are obtained by performing a bitwise addition on the at least two one-dimensional feature vectors. An integer sequence is obtained by performing mapping on features in the processed one-dimensional feature vector based on the multimodal word list, and a combined modality marker processing is performed on the integer sequence. The combination modality marker is, for example, a sound video marker, etc.

In an embodiment of the present disclosure, in the case that at least two candidate sample generation data under the non-textual modality with the association relationship exist in the sample generation data, the backbone network may also generate an integer sequence of a combined modality when outputting the predicted integer sequence combination for the at least two candidate non-textual modalities with the association relationship. The predicted generation data under the at least two candidate non-textual modalities is obtained by inputting the integer sequence into the decoding networks in the codec networks corresponding to the at least two candidate non-textual modalities, respectively.

The generation processing of the integer sequence of the combined modality enables the multimodal large model to realize simultaneous generation of the predicted generation data under at least two candidate non-textual modalities.

At step 305, a loss function value of the backbone network is determined based on the sample generation data and the predicted generation data.

In an embodiment of the present disclosure, the electronic device may determine the loss function value of the backbone network based on the sample generation data, the predicted generation data, and the loss function of the multimodal large model.

At step 306, a training is performed by adjusting a parameter of the backbone network based on the loss function value.

It should be noted that the details of steps 301 to step 303 can be referred to steps 101 to step 103 in the embodiments shown in FIG. 1, and will not be described in detail herein.

With the method for training a multimodal large model according to embodiments of the present disclosure, the first training data and the second training data are obtained; in which the first training data includes data under multiple non-textual modalities, and the second training data includes the multimodal sample reference data and the sample generation data under a target task, the initial multimodal large model is obtained, in which the multimodal large model includes the backbone network and the multiple codec networks corresponding to the multiple non-textual modalities, and the multiple codec networks perform encoding and decoding based on the same multimodal word list, the joint training is performed on the multiple codec networks and the multimodal word list based on the data under the multiple non-textual modalities, the predicted generation data is generated based on the multimodal sample reference data, the multiple codec networks corresponding to the multiple non-textual modalities, and the backbone network, the loss function value of the backbone network is determined based on the sample generation data and the predicted generation data, and a training is performed by adjusting the parameter of the backbone network based on the loss function value. The predicted generation data is determined based on the multimodal sample reference data, the multiple codec networks corresponding to the multiple non-textual modalities, and the backbone network, and the loss function value of the backbone network is also determined for adjustment, thus improving the training speed and training accuracy of the backbone network.

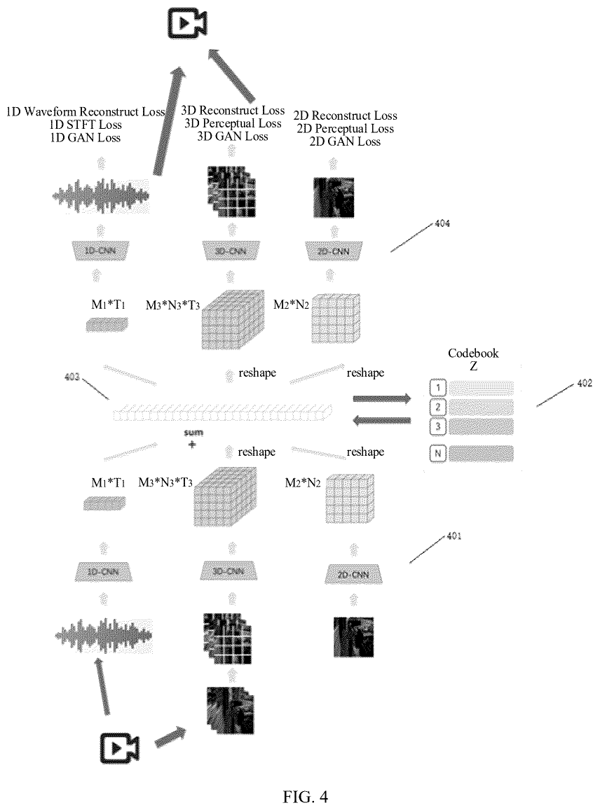

The following is an embodiment for illustration. As shown in FIG. 4, it is a schematic diagram illustrating training of multiple codec networks in a multimodal large model. In FIG. 4, the following steps 401 to 404 may be included. At step 401, an output audio feature is obtained by inputting an audio into a coding network in a 1D-CNN (a codec network corresponding to an audio modality); an output video feature is obtained by inputting a video into a coding network in a 3D-CNN (a codec network corresponding to a video modality); and an output image feature is obtained by inputting an image into a coding network in a 2D-CNN (a codec network corresponding to the image modality). At step 402, a one-dimensional feature vector corresponding to the image and a one-dimensional feature vector corresponding to the video are obtained by performing a one-dimensional deformation on the image feature and the video feature, respectively. In a case that the audio is a dubbing corresponding to the video, i.e., a sound video is obtained by combining the audio and the video, a processed one-dimensional feature vector is obtained by summing (a bitwise addition) the audio feature (a one-dimensional feature vector) corresponding to the audio and a one-dimensional feature vector corresponding to the video. At step 403, an integer sequence corresponding to the image and a processed integer sequence are obtained, by performing mapping on the one-dimensional feature vector corresponding to the image and the processed one-dimensional feature vector respectively based on the a codebook (a multimodal word list). The processed integer sequence may be used as an integer sequence corresponding to the audio and an integer sequence corresponding to the video, respectively. At step 404, a predicted audio, a predicted image, and a predicted video are obtained by determination, based on the integer sequence corresponding to the audio, the integer sequence corresponding to the image, the integer sequence corresponding to the video, the decoding network of the 1D-CNN, the decoding network of the 2D-CNN, and the decoding network of the 3D-CNN, to perform a joint training on the 1D-CNN, 2D-CNN and 3D-CNN.

FIG. 5 is a schematic diagram illustrating a fourth embodiment according to the present disclosure. It should be noted that the method for processing a target task in embodiments of the present disclosure may be applied to an apparatus for processing a target task, which may be configured in an electronic device to enable the electronic device to perform a function for processing a target task. In the following embodiments, the execution subject is illustrated as the electronic device.

The electronic device may be any device with computing capabilities, such as a PC, a mobile terminal, a server, etc. The mobile terminal can be, for example, an in-vehicle device, a smartphone, a tablet, a personal digital assistant, a wearable device, a smart speaker, a server, a server cluster, or other hardware devices with various operating systems, touch screens, and/or displays.

The apparatus for processing a target task may also be software in the electronic device, such as software for the processing a target task etc. In the following embodiments, the apparatus for processing a target task is illustrated as the electronic device.

As shown in FIG. 5, the method for processing a target task may include the following steps 501 to 503.

At step 501, a target task is obtained; in which the target task includes data under at least two modalities.

In an embodiment of the present disclosure, the target task includes at least one of: an image generation task, a video generation task, an audio generation task, a text generation task, or a multi-modality understanding task. The data under at least two modalities included in the target task is data that is used in performing the target task.

In the case that the target task is the image generation task, if the image generation task is performing image generation based on the image and the text, correspondingly, the image generation task may include data under the image modality and data under the text modality. In the case that the target task is the video generation task, if the video generation task is performing video generation based on the image and the audio, correspondingly, the video generation task may include data under the image modality and data under the audio modality.

The configuration of the multiple target tasks enables the multimodal large model to process data under the multiple target tasks, thus expanding the task applicability scenarios of the multimodal large model.

At step 502, a multimodal large model is obtained; in which the multimodal large model is obtained based on the method for training a multimodal large model according to any one of embodiments in FIG. 1 to FIG. 3.

In an embodiment of the present disclosure, the multimodal large model includes a backbone network and multiple codec networks corresponding to the multiple non-textual modalities; and the multiple codec networks perform encoding and decoding based on a same multimodal word list.

The multiple codec networks may, for example, include a one-dimensional codec network, a two-dimensional codec network, a three-dimensional codec network, and etc. The one-dimensional codec network is a codec network corresponding to the audio modality. The two-dimensional codec network is a codec network corresponding to the image modality. The three-dimensional codec network is a codec network corresponding to the video modality.

At step 503, generated data output by the multimodal large model is obtained, by inputting the data under the at least two modalities into the multimodal large model.

In an embodiment of the present disclosure, in the case that the at least two modalities are the image modality, the audio modality, the video modality, and the text modality, the process of performing step 503 by the electronic device may, for example, include: determining an integer sequence corresponding to the image by inputting the image under the image modality into the two-dimensional codec network; determining an integer sequence corresponding to the audio by inputting the audio under the audio modality into the one-dimensional codec network; determining an integer sequence corresponding to the video by inputting the video under the video modality into the three-dimensional codec network; dividing the text in the text modality into words, and then determining an integer sequence corresponding to the text based on integer identifiers corresponding to the words in the text word list; obtaining a processed integer sequence combination by splicing the integer sequence corresponding to the image, the integer sequence corresponding to the audio, the integer sequence corresponding to the video, and the integer sequence corresponding to the text and performing modality marking; obtaining predicted integer sequences or a predicted integer sequence combination output by the backbone network, by inputting the processed integer sequence combination into the backbone network; and determining the generation data based on the predicted integer sequence or the predicted integer sequence combination, and the decoding network in the multiple codec networks.

In an embodiment of the present disclosure, the data under at least two modalities in the target task may have an association relationship. In the case that the target task includes data under the audio modality, data under the video modality, and data under the image modality, and the data under the audio modality has an association relationship with the data under the video modality, the electronic device may obtain an output audio data feature by inputting the data under the audio modality into a coding network in a codec network corresponding to the audio modality; in which the audio data feature is a one-dimensional feature vector. The electronic device may obtain the output video data feature by inputting the data under the video modality into a coding network in a codec network corresponding to the video modality, and obtain a one-dimensional feature vector by performing a one-dimensional deformation on the video data feature. The electronic device may obtain an integer sequence, by performing a bitwise addition on two one-dimensional feature vectors and performing mapping on features based on the multimodal word list, and perform a combination and modality marker processing on the integer sequence, i.e., performing a sound video marker processing.

In an embodiment of the present disclosure, in the case where the target task is to generate data under at least two non-textual modalities with an association relationship, the backbone network may generate an integer sequence of a combined modality when outputting the predicted integer sequence combination for the at least two candidate non-textual modalities with the association relationship. The predicted generation data under the at least two candidate non-textual modalities may be obtained by inputting the integer sequence into the decoding networks in the codec networks corresponding to the at least two candidate non-textual modalities, respectively. Thus, the simultaneous generation of the predicted generation data under at least two candidate non-textual modalities with an association relationship is realized.

With the method for processing a target task according to embodiments of the present disclosure, the target task is obtained; in which the target task includes data under at least two modalities; the multimodal large model is obtained; in which the multimodal large model is obtained based on the method for training a multimodal large model according to any one of embodiments in FIG. 1 to FIG. 3; and generated data output by the multimodal large model is obtained by inputting the data under at least two modalities into the multimodal large model. The multiple codec networks in the multimodal large model perform encoding and decoding based on a same multimodal word list and achieve a unified modeling of the data under the multiple modalities, improving the accuracy of the generated data obtained by determination.

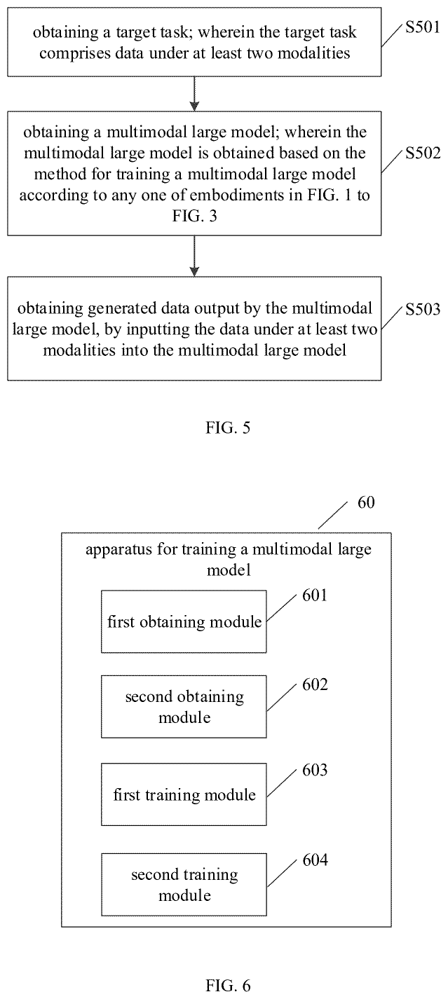

To implement the above embodiments, an apparatus for training a multimodal large model is also provided in the present disclosure. As shown in FIG. 6, it is a schematic diagram illustrating a fifth embodiment according to the present disclosure. The apparatus 60 for training a multimodal large model may include: a first obtaining module 601, a second obtaining module 602, a first training module 603, and a second training module 604.

The first obtaining module 60 is configured to obtain first training data and second training data; in which the first training data includes data under multiple non-textual modalities; and the second training data includes multimodal sample reference data and sample generation data under a target task. The second obtaining module 602 is configured to obtain an initial multimodal large model; in which the multimodal large model includes a backbone network and multiple codec networks corresponding to the multiple non-textual modalities; and the multiple codec networks perform encoding and decoding based on a same multimodal word list. The first training module 603 is configured to perform a joint training on the multiple codec networks and the multimodal word list based on the data under the multiple non-textual modalities. The second training module 604 is configured to, in response to the training of the multiple codec networks and the multimodal word list being completed, train the backbone network based on the multimodal sample reference data and the sample generation data under the target task.

As a possible implementation of an embodiment of the present disclosure, the first training module 603 includes a first determining unit and a first adjusting unit. The first determining unit is configured to determine loss function values of the multiple codec networks corresponding to the multiple non-textual modalities based on the data under the multiple non-textual modalities and the multiple codec networks corresponding to the multiple non-textual modalities. The first adjusting unit is configured to perform the joint training by adjusting, based on the loss function values of the multiple codec networks corresponding to the multiple non-textual modalities, each codec network and the multimodal word list.

As a possible implementation of an embodiment of the present disclosure, the first determining unit includes a first determining subunit, a second determining subunit and a third determining subunit. The first determining subunit is configured to determine predicted data corresponding to the data under the multiple non-textual modalities based on the data under the multiple non-textual modalities and the multiple codec networks corresponding to the multiple non-textual modalities. The second determining subunit is configured to determine, for each non-textual modality, a true-false discriminatory result based on the data under the non-textual modality, the predicted data corresponding to the data under the non-textual modality, and a discriminatory network in a codec network corresponding to the non-textual modality. The third determining subunit is configured to determine a loss function value of the codec network corresponding to the non-textual modality based on at least one of the true-false discrimination result, a difference between the data and the predicted data, or a difference in features between the data and the predicted data.

As a possible implementation of an embodiment of the present disclosure, the first determining subunit is specifically configured to determine whether at least two candidate data with an association relationship exist in the data under the multiple non-textual modalities; in which the at least two candidate data belong to different non-textual modalities; and in response to the at least two candidate data not existing in the data under the multiple non-textual modalities, obtain, for each non-textual modality, prediction data corresponding to data under the non-textual modality by inputting the data under the non-textual modality into a codec network corresponding to the non-textual modality, sequentially.

As a possible implementation of an embodiment of the present disclosure, the first determining subunit is further configured to in response to the at least two candidate data existing in the data under the multiple non-textual modalities, obtain at least two data features corresponding to the at least two candidate data respectively, by inputting the at least two candidate data into coding networks in codec networks corresponding to respective modalities to which the at least two candidate data belong, respectively; obtain a processed one-dimensional feature vector by performing a one-dimensional deformation and a bitwise addition on the at least two data features; obtain a processed integer sequence by performing mapping on features in the processed one-dimensional feature vector based on the multimodal word list; and determine predicted data corresponding to the at least two candidate data based on the processed integer sequence and decoding networks in the codec networks corresponding to the respective modalities to which the at least two candidate data belong.

As a possible implementation of an embodiment of the present disclosure, the first adjusting unit is configured to obtain a total loss function value by summing the loss function values of the multiple codec networks corresponding to the multiple non-textual modalities; and perform the joint training by adjusting, based on the total loss function value, parameters of the multiple codec networks and a vector corresponding to an integer identifier in the multimodal word list.

As a possible implementation of an embodiment of the present disclosure, the multiple non-textual modalities include at least one of: an audio modality, a silent video modality, or an image modality; in which a codec network corresponding to the audio modality is a one-dimensional codec network; a codec network corresponding to the silent video modality is a three-dimensional codec network; and a codec network corresponding to the image modality is a two-dimensional codec network.

As a possible implementation of an embodiment of the present disclosure, a method for processing an image under the image modality based on a coding network in the two-dimensional codec network includes: obtaining a two-dimensional image feature by inputting the image into the coding network in the two-dimensional codec network; obtaining a deformed one-dimensional feature vector by performing a one-dimensional deformation on the two-dimensional image feature; and obtaining an integer sequence corresponding to the image by performing mapping on features in the one-dimensional feature vector based on the multimodal word list.

As a possible implementation of an embodiment of the present disclosure, a combination of the at least two candidate data with the association relationship includes: a sound video.

As a possible implementation of an embodiment of the present disclosure, the second obtaining module 604 includes a second determining unit, a third determining unit and a second adjusting unit. The second determining unit is configured to determine predicted generation data based on the multimodal sample reference data, the multiple codec networks corresponding to the multiple non-textual modalities, and the backbone network; the third determining unit is configured to determine a loss function value of the backbone network based on the sample generation data and the predicted generation data; and the second adjusting unit is configured to perform a training by adjusting a parameter of the backbone network based on the loss function value.

As a possible implementation of an embodiment of the present disclosure, the second determining unit is specifically configured to determine a multimodal integer sequence combination based on the multimodal sample reference data and coding networks in the multiple codec networks corresponding to the multiple non-textual modalities; in which integer sequences under different modalities in the multimodal integer sequence combination are distinguished through modality markers; obtain predicted integer sequences or a predicted integer sequence combination output by the backbone network, by inputting the multimodal integer sequence combination into the backbone network; and obtain the predicted generation data, by inputting the predicted integer sequences or predicted integer sequences in the predicted integer sequence combination into decoding networks in the multiple codec networks corresponding to the multiple modalities, respectively.

As a possible implementation of an embodiment of the present disclosure, the multimodal sample reference data includes sample reference data under multiple candidate non-textual modalities and sample text data under a textual modality. The second determining unit is further specifically configured to determine, for each candidate non-textual modality, an integer sequence under the candidate non-textual modality based on sample reference data under the candidate non-textual modality and a coding network in a codec network corresponding to the candidate non-textual modality; and obtain the multimodal integer sequence combination by splicing integer sequences under the multiple candidate non-textual modalities and an integer sequence corresponding to the sample text data based on the modality markers.

As a possible implementation of an embodiment of the present disclosure, the multimodal sample reference data includes data under at least two of following modalities: an audio modality, a silent video modality, an image modality, or a text modality; and the sample generation data includes data under at least one of following modalities: an audio modality, a silent video modality, an image modality, or a text modality.

As a possible implementation of an embodiment of the present disclosure, the target task includes at least one of: an image generation task, a video generation task, an audio generation task, a text generation task, or a multi-modality understanding task.

In embodiments of the present disclosure, an apparatus for training a multimodal large model is provided. The apparatus is configured to obtain first training data and second training data; in which the first training data includes data under multiple non-textual modalities; and the second training data includes multimodal sample reference data and sample generation data under a target task; obtain an initial multimodal large model; in which the multimodal large model includes a backbone network and multiple codec networks corresponding to the multiple non-textual modalities; and the multiple codec networks perform encoding and decoding based on a same multimodal word list; perform a joint training on the multiple codec networks and the multimodal word list based on the data under the multiple non-textual modalities; and in response to the training of the multiple codec networks and the multimodal word list being completed, train the backbone network based on the multimodal sample reference data and the sample generation data under the target task. The multiple codec networks perform encoding and decoding and the joint training based on the same multimodal word list, avoiding training word lists of different modalities separately during the training process, thus reducing the difficulty and the cost of the model training.

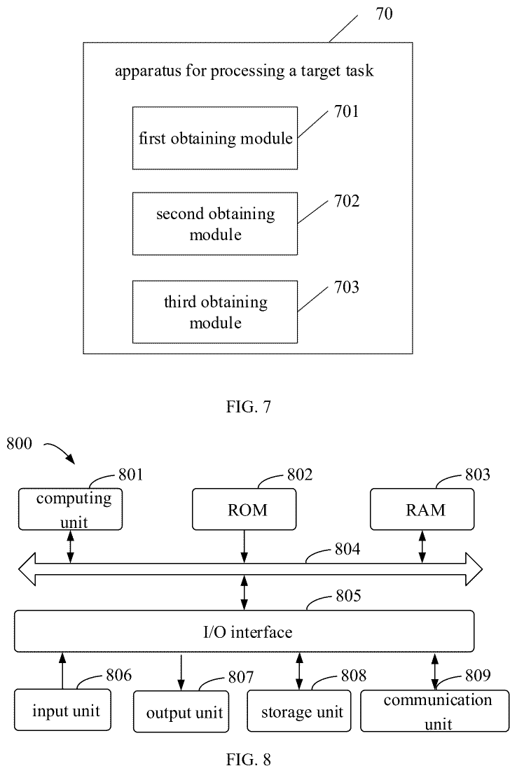

To implement the above embodiments, an apparatus for processing a target task is also provided in the present disclosure. As shown in FIG. 7, it is a schematic diagram illustrating a sixth embodiment according to the present disclosure. The apparatus 70 for processing a target task may include: a first obtaining module 701, a second obtaining module 702, and a third obtaining module 703.

The first obtaining module 70 is configured to obtain a target task; in which the target task includes data under at least two modalities. The second obtaining module 702 is configured to obtain a multimodal large model; in which the multimodal large model is obtained based on the method for training a multimodal large model according to any one of methods in embodiments in FIG. 1 to FIG. 3. The third obtaining module 703 is configured to obtain generated data output by the multimodal large model, by inputting the data under at least two modalities into the multimodal large model.

As a possible implementation of an embodiment of the present disclosure, the target task includes at least one of: an image generation task, a video generation task, an audio generation task, a text generation task, a multi-modality understanding task.

In embodiments of the present disclosure, an apparatus for processing a target task is provided. The apparatus is configured to obtain a target task; in which the target task includes data under at least two modalities; obtain a multimodal large model; in which the multimodal large model is obtained based on the method for training a multimodal large model according to any one of methods in embodiments in FIG. 1 to FIG. 3; and obtain generated data output by the multimodal large model, by inputting the data under at least two modalities into the multimodal large model. The multiple codec networks in the multimodal large model perform encoding and decoding based on a same multimodal word list and achieve a unified modeling of the data under the multiple modalities, improving the accuracy of the generated data obtained by determination.

In the technical solution of the disclosure, the acquisition, storage, application, processing, transmission, provision and disclosure of the personal information of the users are all carried out under the premise of obtaining the consent of the users and are in compliance with relevant laws and regulations, and do not violate public order and morals.

According to embodiments of the present disclosure, it also provides an electronic device, a readable storage medium, and a computer program product.

Referring to FIG. 8, it is a block diagram illustrating an electronic device 800 according to an embodiment of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 8, the device 800 includes a computing unit 801, configured to execute various appropriate actions and processes according to a computer program stored in a read-only memory (ROM) 802 or a computer program loaded from a storage unit 808 to a random access memory (RAM) 803. In the RAM 803, various programs and data required for the device 800 may be stored. The computing unit 801, the ROM 802 and the RAM 803 may be connected with each other by a bus 804. An input/output (I/O) interface 805 is also connected to the bus 804.

The plurality of components in the device 800 are connected to the I/O interface 805, which include: an input unit 806, for example, a keyboard, a mouse; an output unit 807, for example, various types of displays, speakers; a storage unit 808, for example, a magnetic disk, an optical disk; and a communication unit 809, for example, a network card, a modem, a wireless transceiver. The communication unit 809 allows the device 800 to exchange information/data through a computer network such as Internet and/or various types of telecommunication networks with other devices.

The computing unit 801 may be various types of general and/or dedicated processing components with processing and computing abilities. Some examples of a computing unit 801 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 801 executes various methods and processes as described above, for example, a method for training a multimodal large model, or a method for processing a target task. For example, in some embodiments, the method for training a multimodal large model, or the method for processing a target task may be further implemented as a computer software program, which is tangibly contained in a machine readable medium, such as the storage unit 808. In some embodiments, a part or all of the computer program may be loaded and/or installed on the device 800 via the ROM 802 and/or the communication unit 809. When the computer program is loaded on the RAM 803 and executed by the computing unit 801, one or more steps in the method for training a multimodal large model, or the method for processing a target task may be performed as described above. Optionally, in other embodiments, the computing unit 801 may be configured to the method for training a multimodal large model, or the method for processing a target task in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for training a multimodal large model, comprising:
obtaining first training data and second training data; wherein the first training data comprises data under multiple non-textual modalities; and the second training data comprises multimodal sample reference data and sample generation data under a target task;
obtaining an initial multimodal large model; wherein the multimodal large model comprises a backbone network and multiple codec networks corresponding to the multiple non-textual modalities; and the multiple codec networks perform encoding and decoding based on a same multimodal word list;
performing a joint training on the multiple codec networks and the multimodal word list based on the data under the multiple non-textual modalities; and
in response to the training of the multiple codec networks and the multimodal word list being completed, training the backbone network based on the multimodal sample reference data and the sample generation data under the target task.

2. The method according to claim 1, wherein performing the joint training on the multiple codec networks and the multimodal word list based on the data under the multiple non-textual modalities comprises:
determining loss function values of the multiple codec networks corresponding to the multiple non-textual modalities based on the data under the multiple non-textual modalities and the multiple codec networks corresponding to the multiple non-textual modalities; and
performing the joint training by adjusting, based on the loss function values of the multiple codec networks corresponding to the multiple non-textual modalities, each codec network and the multimodal word list.

3. The method according to claim 2, wherein determining the loss function values of the multiple codec network corresponding to the multiple non-textual modalities based on the data under the multiple non-textual modalities and the multiple codec networks corresponding to the multiple non-textual modalities comprises:
determining predicted data corresponding to the data under the multiple non-textual modalities based on the data under the multiple non-textual modalities and the multiple codec networks corresponding to the multiple non-textual modalities;
determining, for each non-textual modality, a true-false discriminatory result based on the data under the non-textual modality, the predicted data corresponding to the data under the non-textual modality, and a discriminatory network in a codec network corresponding to the non-textual modality; and
determining a loss function value of the codec network corresponding to the non-textual modality based on at least one of the true-false discrimination result, a difference between the data and the predicted data, or a difference in features between the data and the predicted data.

4. The method according to claim 3, wherein determining the predicted data corresponding to the data under the multiple non-textual modalities based on the data under the multiple non-textual modalities and the multiple codec networks corresponding to the multiple non-textual modalities comprises:
determining whether at least two candidate data with an association relationship exist in the data under the multiple non-textual modalities; wherein the at least two candidate data belong to different non-textual modalities; and
in response to the at least two candidate data not existing in the data under the multiple non-textual modalities, obtaining, for each non-textual modality, prediction data corresponding to data under the non-textual modality by inputting the data under the non-textual modality into a codec network corresponding to the non-textual modality, sequentially.

5. The method according to claim 4, wherein determining the predicted data corresponding to the data under the multiple non-textual modalities based on the data under the multiple non-textual modalities and the multiple codec networks corresponding to the multiple non-textual modalities comprises:
in response to the at least two candidate data existing in the data under the multiple non-textual modalities, obtaining at least two data features corresponding to the at least two candidate data respectively, by inputting the at least two candidate data into coding networks in codec networks corresponding to respective modalities to which the at least two candidate data belong, respectively;
obtaining a processed one-dimensional feature vector by performing a one-dimensional deformation and a bitwise addition on the at least two data features;
obtaining a processed integer sequence by performing mapping on features in the processed one-dimensional feature vector based on the multimodal word list; and
determining predicted data corresponding to the at least two candidate data based on the processed integer sequence and decoding networks in the codec networks corresponding to the respective modalities to which the at least two candidate data belong.

6. The method according to claim 2, wherein performing the joint training by adjusting, based on the loss function values of the multiple codec networks corresponding to the multiple non-textual modalities, each codec network and the multimodal word list comprises:
obtaining a total loss function value by summing the loss function values of the multiple codec networks corresponding to the multiple non-textual modalities; and
performing the joint training by adjusting, based on the total loss function value, parameters of the multiple codec networks and a vector corresponding to an integer identifier in the multimodal word list.

7. The method according to claim 1, wherein the multiple non-textual modalities comprise at least one of: an audio modality, a silent video modality, or an image modality;
wherein a codec network corresponding to the audio modality is a one-dimensional codec network; a codec network corresponding to the silent video modality is a three-dimensional codec network; and a codec network corresponding to the image modality is a two-dimensional codec network.

8. The method according to claim 7, wherein a method for processing an image under the image modality based on a coding network in the two-dimensional codec network comprises:
obtaining a two-dimensional image feature by inputting the image into the coding network in the two-dimensional codec network;
obtaining a deformed one-dimensional feature vector by performing a one-dimensional deformation on the two-dimensional image feature; and
obtaining an integer sequence corresponding to the image by performing mapping on features in the one-dimensional feature vector based on the multimodal word list.

9. The method according to claim 4, wherein a combination of the at least two candidate data with the association relationship comprises: a sound video.

10. The method according to claim 1, wherein training the backbone network based on the multimodal sample reference data and the sample generation data under the target task in response to the training of the multiple codec networks and the multimodal word list being complete comprises:
determining predicted generation data based on the multimodal sample reference data, the multiple codec networks corresponding to the multiple non-textual modalities, and the backbone network;
determining a loss function value of the backbone network based on the sample generation data and the predicted generation data; and
performing a training by adjusting a parameter of the backbone network based on the loss function value.

11. The method according to claim 10, wherein determining predicted generation data based on the multimodal sample reference data, the multiple codec networks corresponding to the multiple non-textual modalities, and the backbone network comprises:
determining a multimodal integer sequence combination based on the multimodal sample reference data and coding networks in the multiple codec networks corresponding to the multiple non-textual modalities; wherein integer sequences under different modalities in the multimodal integer sequence combination are distinguished through modality markers;
obtaining predicted integer sequences or a predicted integer sequence combination output by the backbone network, by inputting the multimodal integer sequence combination into the backbone network; and
obtaining the predicted generation data, by inputting the predicted integer sequences or predicted integer sequences in the predicted integer sequence combination into decoding networks in the multiple codec networks corresponding to the multiple modalities, respectively.

12. The method according to claim 11, wherein the multimodal sample reference data comprises sample reference data under multiple candidate non-textual modalities and sample text data under a textual modality; wherein determining the multimodal integer sequence combination based on the multimodal sample reference data and the coding networks in the multiple codec networks corresponding to the multiple non-textual modalities comprises:
determining, for each candidate non-textual modality, an integer sequence under the candidate non-textual modality based on sample reference data under the candidate non-textual modality and a coding network in a codec network corresponding to the candidate non-textual modality; and
obtaining the multimodal integer sequence combination by splicing integer sequences under the multiple candidate non-textual modalities and an integer sequence corresponding to the sample text data based on the modality markers.

13. The method according to claim 1, wherein the multimodal sample reference data comprises data under at least two of following modalities: an audio modality, a silent video modality, an image modality, or a text modality;
and the sample generation data comprises data under at least one of following modalities: an audio modality, a silent video modality, an image modality, or a text modality.

14. The method according to claim 1, wherein the target task comprises at least one of: an image generation task, a video generation task, an audio generation task, a text generation task, or a multi-modality understanding task.

15. A method for processing a target task, comprising:
obtaining a target task; wherein the target task comprises data under at least two modalities;
obtaining a multimodal large model; wherein the multimodal large model is obtained based on a method for training a multimodal large model; and
obtaining generated data output by the multimodal large model, by inputting the data under the at least two modalities into the multimodal large model;
wherein the method for training a multimodal large model comprises:
obtaining first training data and second training data; wherein the first training data comprises data under multiple non-textual modalities; and the second training data comprises multimodal sample reference data and sample generation data under a target task;
obtaining an initial multimodal large model; wherein the multimodal large model comprises a backbone network and multiple codec networks corresponding to the multiple non-textual modalities; and the multiple codec networks perform encoding and decoding based on a same multimodal word list;
performing a joint training on the multiple codec networks and the multimodal word list based on the data under the multiple non-textual modalities; and
in response to the training of the multiple codec networks and the multimodal word list being completed, training the backbone network based on the multimodal sample reference data and the sample generation data under the target task.

16. The method according to claim 15, wherein the target task comprises at least one of: an image generation task, a video generation task, an audio generation task, a text generation task, or a multi-modality understanding task.

17. An electronic device, comprising:
at least one processor; and
a memory communicatively coupled to the at least one processor and storing instructions executable by the at least one processor;
wherein the processor is configured to:
obtain first training data and second training data; wherein the first training data comprises data under multiple non-textual modalities; and the second training data comprises multimodal sample reference data and sample generation data under a target task;
obtain an initial multimodal large model; wherein the multimodal large model comprises a backbone network and multiple codec networks corresponding to the multiple non-textual modalities; and the multiple codec networks perform encoding and decoding based on a same multimodal word list;
perform a joint training on the multiple codec networks and the multimodal word list based on the data under the multiple non-textual modalities; and
in response to the training of the multiple codec networks and the multimodal word list being completed, train the backbone network based on the multimodal sample reference data and the sample generation data under the target task.

18. An electronic device, comprising:
at least one processor; and
a memory communicatively coupled to the at least one processor and storing instructions executable by the at least one processor;
wherein the processor is configured to perform claim 15.

19. A non-transitory computer readable storage medium, storing computer instructions, wherein the computer instructions are caused to enable a computer to perform the method according to claim 1.

20. A non-transitory computer readable storage medium, storing computer instructions, wherein the computer instructions are caused to enable a computer to perform the method according to claim 15.
